(19) United States
(12) Patent Application Publication
(10) Pub. No.: US 2022/0210150 A1
(43) Pub. Date: Jun. 30, 2022

(54) METHOD AND APPARATUS FOR PROVIDING DEVICE-GENERATED AND BIOMETRICALLY-SIGNED LOCATION TRACE DATA TO PROVE PROXIMITY TO A DEVICE

(71) Applicant: HERE Global B.V., Eindhoven (NL)

(72) Inventors: Nicolas NEUBAUER, Berlin (DE); Jerome BEAUREPAIRE, Berlin (DE)

(21) Appl. No.: 17/138,533

(22) Filed: Dec. 30, 2020

(51) Int. Cl. H04L 29/06; H04W 12/63; G06F 16/29

(52) U.S. Cl. CPC H04L 63/0861; H04L 63/107; G06F 16/29; H04W 12/63

(57) ABSTRACT

An approach is provided for providing biometrically-signed location trace data at a device as a proof of user presence. The approach involves initiating a transmission of location data generated by one or more location sensors of a device. The approach also involves, in response to the transmission, receiving a challenge generated for the location data. The approach further involves generating a biometric mapping message based on the challenge and biometric data of a user. The user is associated with the device at a time the location data was generated. The approach further involves providing the biometric mapping message as an output. The output of the biometric mapping message indicates a proof of a presence of the user within a proximity of the device at the time the location data was generated.

### BACKGROUND

Since the outbreak of COVID-19, state and local public health authorities are trying to trace infected cases and close contacts based on self-reporting, camera-monitoring, contact tracing applications, etc., in order to slow the spread of COVID-19 and protect the public. However, these approaches are susceptible to human manipulation and do not provide a general solution (e.g., also applicable outside of the COVID-19 context) to prove with a high level of certainty that a specific user was near a device which reported its location at a given time. In addition, the state and local public health authorities can demand a user to prove that the user was not exposed when travelling in a vehicle via a (e.g., COVID-19) contaminated area. Accordingly, service providers and manufacturers of user devices and vehicles face significant technical challenges to develop mechanisms for proving user locations with a device, as well as mechanisms for proving that the user stayed within a vehicle the whole time travelling via a contaminated area.

### SOME EXAMPLE EMBODIMENTS

Therefore, there are needs for approaches for providing biometrically-signed location trace data at a device as a proof of user presence, for example, with respect to contact tracing and travelling via a contaminated area.

According to one or more example embodiments, a method comprises initiating a transmission of location data generated by one or more location sensors of a device. The method also comprises, in response to the transmission, receiving a challenge generated for the location data. The method further comprises generating a biometric mapping message based on the challenge and biometric data of a user. The user is associated with the device at a time the location data was generated. The method further comprises providing the biometric mapping message as an output. The output of the biometric mapping message indicates a proof of a presence of the user within a proximity of the device at the time the location data was generated.

According to another embodiment, an apparatus comprises at least one processor, and at least one memory including computer program code for one or more programs, the at least one memory and the computer program code configured to, with the at least one processor, to cause, at least in part, the apparatus to initiate a transmission of location data generated by one or more location sensors of a device. The apparatus is also caused to, in response to the transmission, receive a challenge generated for the location data. The apparatus is further caused to generate a biometric mapping message based on the challenge and biometric data of a user. The user is associated with the device at a time the location data was generated. The apparatus is further caused to provide the biometric mapping message as an output. The output of the biometric mapping message indicates a proof of a presence of the user within a proximity of the device at the time the location data was generated.

According to another embodiment, a computer-readable storage medium carrying one or more sequences of one or more instructions which, when executed by one or more processors, cause, at least in part, an apparatus to initiate a transmission of location data generated by one or more location sensors of a device. The apparatus is also caused to, in response to the transmission, receive a challenge generated for the location data. The apparatus is further caused to generate a biometric mapping message based on the challenge and biometric data of a user. The user is associated with the device at a time the location data was generated. The apparatus is further caused to provide the biometric mapping message as an output. The output of the biometric mapping message indicates a proof of a presence of the user within a proximity of the device at the time the location data was generated.

According to another embodiment, an apparatus comprises means for initiating a transmission of location data generated by one or more location sensors of a device. The apparatus also comprises means for, in response to the transmission, receiving a challenge generated for the location data. The apparatus further comprises means for generating a biometric mapping message based on the challenge and biometric data of a user. The user is associated with the device at a time the location data was generated. The apparatus further comprises means for providing the biometric mapping message as an output. The output of the biometric mapping message indicates a proof of a presence of the user within a proximity of the device at the time the location data was generated.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing biometrically-signed location trace data at a device as a proof of user presence, according to one or more example embodiments;

FIG. 2A is a ladder diagram of an example process for signing location trace data generated by a device with personal data/face to prove a user was the individual associated with those location traces, according to one or more example embodiments;

FIG. 2B is a flowchart of a process for a vehicle to generate a proof that a user did not leave the vehicle in a given area, according to one or more example embodiments;

FIG. 3 is a diagram of the components of a location validation platform, according to one or more example embodiments;

FIG. 4 is a flowchart of a process for providing biometrically-signed location trace data at a device as a proof of user presence, according to one or more example embodiments;

FIGS. 5A-5F are diagrams of example user interfaces utilized in providing biometrically-signed location trace data at a device as a proof of user presence, according to one or more example embodiments;

FIG. 6 is a diagram of a geographic database, according to one embodiment;

FIG. 7 is a diagram of hardware that can be used to implement an embodiment of the invention, according to one or more example embodiments;

FIG. 8 is a diagram of a chip set that can be used to implement an embodiment of the invention, according to one or more example embodiments; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing biometrically-signed location trace data at a device as a proof of user presence are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

There are mobile applications for tracking user location traces over time, geofences to record people's movements, COVID-19 related applications for contact tracing, etc. However, there is still a need to prove with a high level of certainty that a specific user was near the device which reported its location data at a given time frame, such that the user can prove/validate the location to authorities (e.g., the police, a court, a public health agency, etc.). In addition, there is also a need to unquestionably prove that a user was within a vehicle at a given location/route passing an area of interest (e.g., a car crash, a contaminated area, etc.) at a given time frame, if asked by the authorities to prove the fact.

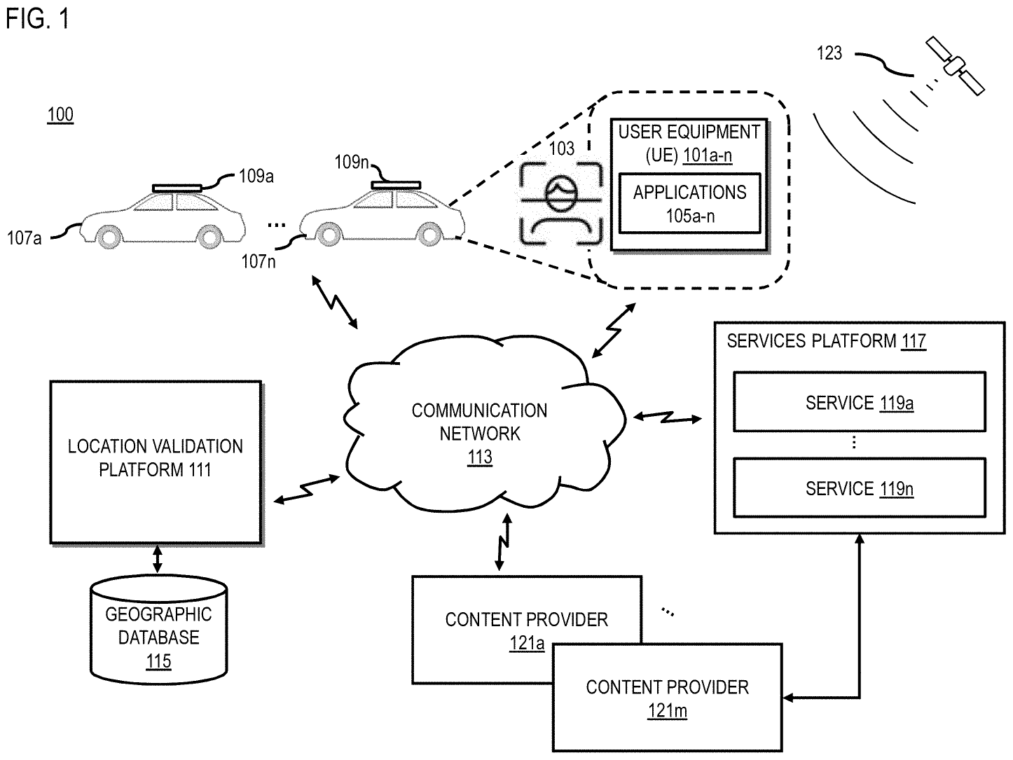

To address these problems, a system 100 of FIG. 1 introduces the capability of providing biometrically-signed location trace data at a device as a proof of user presence. FIG. 1 is a diagram of a system capable of providing biometrically-signed location trace data at a device as a proof of user presence, according to one or more example embodiments. The system 100 can sign device-generated location traces with user biometric data to prove user proximity to the device. In one embodiment, the system 100 can support a user to prove the user was near a reference device (that collects location trace data) by signing device-generated location traces with this user's biometric data 103 (e.g., face). The reference device can be one of user equipment (UE) 101a-101n (e.g., mobile devices, smartphones, etc., also collectively referred to herein as UEs 101) installed with applications 105a-105n (also collectively referred to herein as applications 105 that include one or more biometric applications) and associated with the vehicles 107a-107n (collectively referred to herein as vehicles 107). By way of example, the user can be walking, running, driving or riding in a vehicle 107 (e.g., an autonomous vehicle, a bus, a subway, an airplane, etc.) when biometrically signing device-generated location traces.

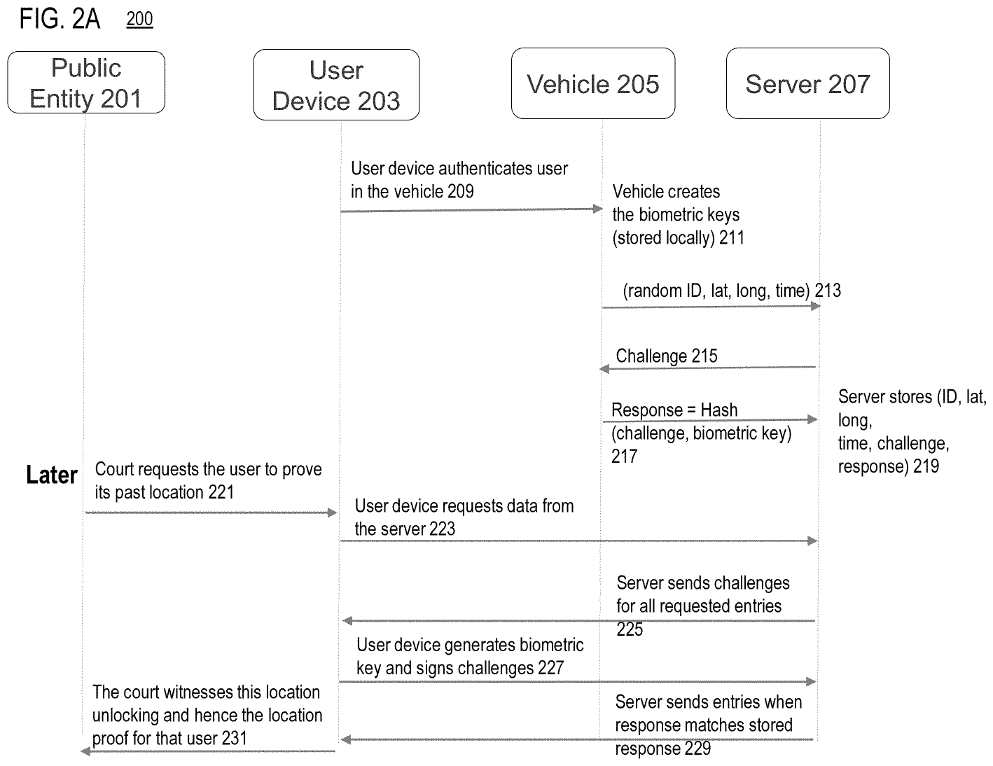

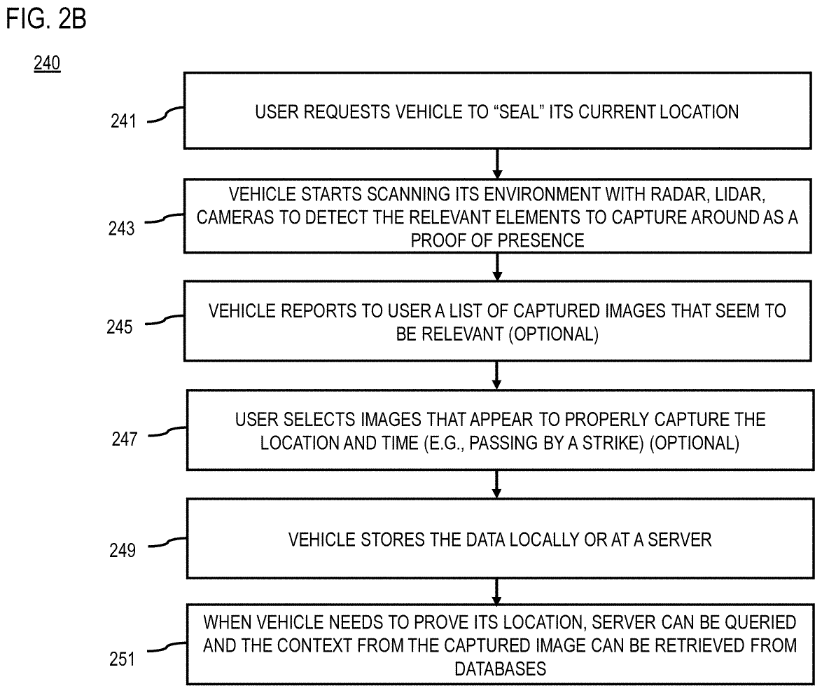

FIG. 2A is a ladder diagram of an example process 200 for signing location trace data generated by a device with personal data/face to prove a user was the individual associated with those location traces, according to one or more example embodiments. By way of example, when required by a public entity 201 (e.g., a court, a public health authority, etc.) to prove a user's location(s) at issue, the user can unlock the user's location trace data by presenting the user's biometric data. In another embodiment, a private entity (e.g., a company, another user, etc.) can replace the public entity 201 in FIG. 2A.

To prove the user was near a user device 203 and/or in a vehicle 205 at a given time using a server 207, the process 200 can start with having the user device 203 authenticate the user (e.g., riding in the vehicle 205) in step 209, e.g., by capturing the biometric data 103 (e.g., face). This capturing of biometric data can be done one or more times along the journey, such as at a predetermined time and/or distance interval, upon sensor data (e.g., proximity sensors) indicating that the user device 203/the vehicle 205 is outside of a distance threshold from the user, upon sensor data patterns indicating that the user device 203/the vehicle 205 may not be with the user at the moment, on demand by the user, etc.). In one instance, the user device 203/the vehicle 205 can use any stable biometric mapping (e.g., face recognition, fingerprint, retina scan, etc.) of the biometric data 103 to generate a unique string for the user and store the biometric data and/or the unique biometric mapping string locally in step 211.

Biometric data can be physiological or behavioral. Physiological data (e.g., face recognition, fingerprint, palm veins, DNA, palm print, hand geometry, iris recognition, retina, odor/scent, pulse rates, etc.) is preferred over behavioral data (e.g., gait, typing rhythm, keystroke, signature, behavioral profiling, etc.) due to more unique mapping possibilities per user. However, physiological data can be more difficult/expensive to collect than behavioral data. The system 100 can consider the capabilities of the user device 203 to recommend which biometric data to capture to sign location trace data.

The vehicle 205 can then randomly generate a location trace data identifier for location trace data (lat, long, time), and then generate and send a location trace data identifier (e.g., a random ID) with the location trace to the server 207 in step 213. The location trace data can be location sensor data of the user device 203, location sensor data of the vehicle 205, and/or probe data of the vehicle 205. A random ID generated for each location trace data can be used instead of a vehicle ID, a UE ID, etc. to improve data privacy, so the server 207 will not have any vehicle ID, any UE ID, etc. associated with the location trace data. In this way, the system 100 can comply with privacy regulations and take steps to obfuscate personal data as much as possible.

Upon receiving the location trace data (random ID, lat, long, time), the server 207 can respond to the vehicle 205 with a randomly generated challenge in step 215 and store the challenge along with the location trace data as (random ID, lat, long, time, challenge). The vehicle 205 can then send back to the server 207 a response that is a hash vale of the biometric mapping string (i.e., a biometric key) and the challenge, i.e., hash (challenge, bio-map(user)), in step 217, which the server 207 also stores with the other data into location trace data entries each including (random ID, lat, long, time, challenge, response) in step 219.

Subsequently, a user wants to prove the location of the user and/or the user's presence in the vehicle 205 at a time point/period at issue, e.g., if the public entity 201 (e.g., a court) requests the user to prove the user's past location in step 221. The user device 203 can request the location trace data from the server 207, for example, based on random ID(s), lat, long, time(s), etc. in step 223. The server 207 can retrieve and re-send the corresponding challenge(s) from the location trace data entries in step 225, and can expect the original response(s) back from the user device 203 which can only be regenerated through the biometric key of the user. Since there is a stable biometric mapping (user) of such a string, a user can always generate the same string, and the string can only be generated by one person.

In one instance, the user device 203 can then re-capture biometric data of the user, generate a biometric key, and sign the challenge(s) with the biometric key into response(s) in step 227, i.e., hash (challenge(s), bio-map(user)). Upon receiving the response(s), the server 207 can retrieve and then send to the user device 203 corresponding location trace data entries (random ID, lat, long, time, challenge, response) in step 229, when the subsequently received response(s) match with stored response(s). Based on the corresponding location trace data entries, the user device 203 can present the location trade data to the court as a proof of location for the user in step 231. For instance, when the proof is required to be presented in the court 201, a witness or court staff can be called to verify the user's identify first, and then the user can be asked to present the biometric data for the user device 203 to retrieve and to present the location(s) at issue (e.g., a court staff could witness that the user is unlocking the location trace(s) with the user's face).

Unlike encryption (a two-way function to encrypt then decrypt data or information with a key), hashing is a one-way function that converts inputs into a unique hash value without decryption. With a properly designed hash function (e.g., a secure hash algorithm (SHA), message digest MD function, etc.), attackers cannot reverse the hashing process to reveal the original inputs. Since user biometric data is used to sign the location trace data at the user device 203 or the vehicle 205 without transmitting the biometric data to the server 207, the system 100 can reliably verify user location data while preserving the privacy of user biometric data.

In this embodiment, the system 100 can apply algorithms for collecting relevant data used as a proof of presence from a user's own device, for collection of nearby devices IDs/hashes within a given range by a main device, for cryptography, for generating random IDs, for stably mapping biometric features into a cryptographic key, and for signing location data with biometric data, thereby proving user presence through a reliably “paired” trusted device for access to legal rights/goods/services, reliably storing biometric data with privacy, and providing a non-falsifiable/unforgeable proof that cannot be reasonably questioned by authorities.

In another embodiment, the system 100 can verify that the user was encapsulated in the vehicle 107 (i.e., did not leave the vehicle 107) to confirm, e.g., that the user was not exposed to a contaminated area during the ride, using vehicle sensor data captured by sensors 109a-109n (e.g., speed sensors, door sensors, safety belt sensors, seats sensors, audio sensors, window sensors, morphological sensors (e.g., user weight, height, pulse rate, etc.), etc., collectively referred to herein as sensors 109) as well as biometrically signed vehicle's probe data and/or device-generated location trace data. For instance, when the location traces reliably show that the vehicle 205 never went below (e.g., 50 kph speed), then the user could not have (highly unlikely) left the vehicle during that period. In one embodiment, the system 100 can prove that the sensor data can be trusted and has not been altered, at least for the area of interest.

As such, the system 100 can ensure/prove that the user did not step out of the vehicle in the contaminated area (e.g., COVID-19) and/or did not stopover in the contaminated area. In addition, the vehicle 107 can generate its proof of presence based on nearby objects (e.g., traffic/speed cameras, tunnel sensors, etc.) and/or other vehicles, e.g., using vehicle-to-vehicle (V2V) communications, vehicle-to-everything (V2X) communications, vehicle to infrastructure (V2I) communications, etc. In one instance, multiple mechanisms can be used together to enhance the confidence level, such as device pairing between the user device 203 with systems in the vehicle 205. For instance, the pairing between the user device 203 and the vehicle 205 via a trusted connection can be achieved with methods such as trusted certificates, authentication protocols (e.g., open authentication (OAuth)), and/or other known mechanisms of establishing and verifying identities between devices.

FIG. 2B is a flowchart of a process 240 for a vehicle to generate a proof that a user did not leave the vehicle in a given area, according to one or more example embodiments. By way of example, passenger(s) of a connected vehicle (e.g., the vehicle 205) may want to prove that they were inside the vehicle in a given location/road in a given timeframe and that they did not stop in an area of interest, such as a contaminated area (e.g., due to COVID-19, chemicals, biological wastes, radioactive materials, environmental hazards, harmful dust/gases/fumes, etc.), a crime scene, an accident scene, a strike/protest, etc. The vehicle 205 can be general modes of transport, a shared vehicle, a private vehicle, a public transport vehicle, a police vehicle, an armored cash transport car, a hazardous waste transporter, etc., provided there is a trusted connection between such vehicle and the device 203.

A user can make a request to the vehicle 205 to “seal” its current location trace data in step 241. The vehicle 205 can start scanning its environment with radar, lidar, cameras, etc. to detect the relevant elements around to capture as a proof of presence at the location in step 243. The vehicle 205 can report to the user a list of captured images from a period of time (e.g., the last three minutes) that seem to be the relevant in an optional step 245. The user can select/validate the images that appear to properly capture the location and time (e.g., passing near a parade/strike) in an optional step 247. The vehicle 205 can store the location-proof data locally and/or externally (e.g., in the server 207 or a cloud) in step 249. Subsequently, when the user/the vehicle 205 needs to prove a previously visited location or to prove that the user/the vehicle 205 never visited a location at issue (e.g., COVID-19), the system 100 can query the server 207 based on a location and/or a time at issue, and then the server 207 can extract context (e.g., a location, a time, etc.) from the captured image(s) in step 251. The server 207 can match extracted location and time with the location and/or the time at issue for verification (i.e., a proof of presence of the vehicle 205). To provide proof that the passengers were indeed in the vehicle 205 at the previously visited location and at the time as proved according to FIG. 2B, the system 100 can apply the process depicted in FIG. 2A. Therefore, the system 100 can prove: (1) the passenger(s)/vehicle has not visited a (e.g., COVID-19) contaminated area, and/or (2) the passenger(s)/vehicle visited the contaminated area yet the passenger(s) remained in the vehicle without being exposed, (e.g., because the vehicle never stopped and/or the passenger(s) never left the vehicle).

In this embodiment, the system 100 can support a vehicle to generate a proof that the user did not leave the vehicle in a given area during a given timeframe, provide proof of presence for a vehicle based on nearby moving objects/vehicles, generate real-time challenges for a vehicle to prove its presence in an area, virtually seal vehicle location data on-demand, incrementally unlock sensor data associated with vehicle location data, determine relevant ephemeral features to be captured around the vehicle as proofs of presence, and use the ephemeral features in conjunction with a database to validate the vehicle's presence at a particular location and time.

In other embodiments, the system 100 can apply the same approach to prove that a vehicle and passengers were not present in a given area at a given timeframe (e.g., by proving that the user was elsewhere at that timeframe), such as that the user/vehicle was not related to an accident that happened in a given area whose cause/fault is still unclear. Other scenarios can include to prove that this user did not “fail to provide assistance” to someone in need in a given area, that the vehicle was not in an area where there was a virus contamination or an area with a high level of radiation, that the vehicle sensor data at the location/time at issue were different from a speeding or parking ticket, etc.

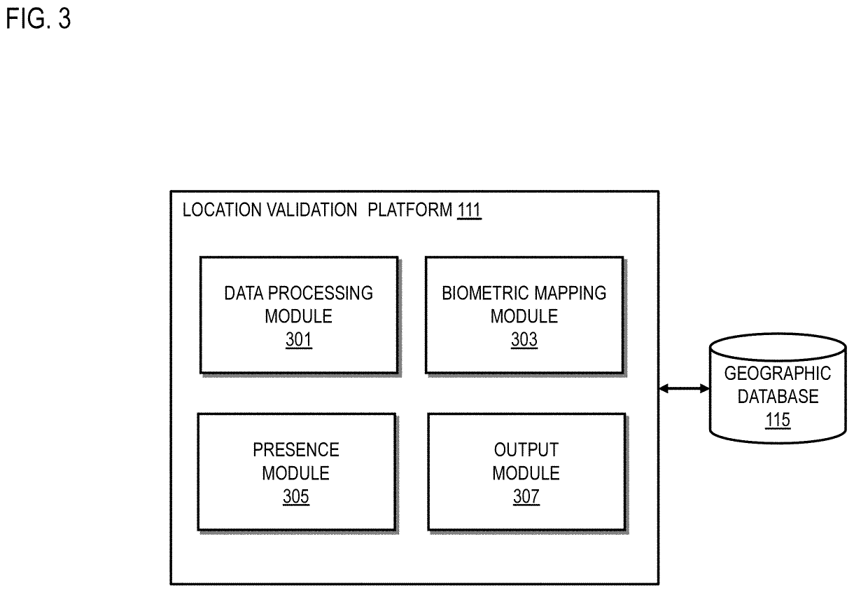

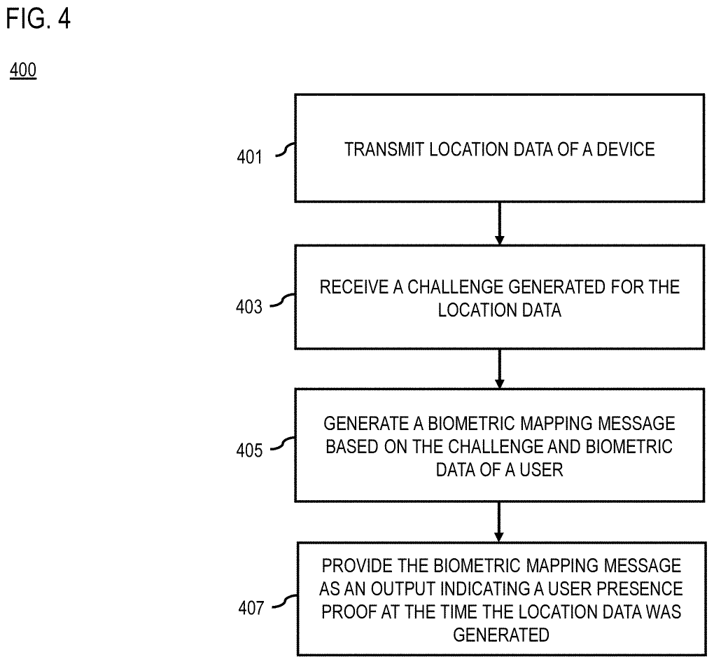

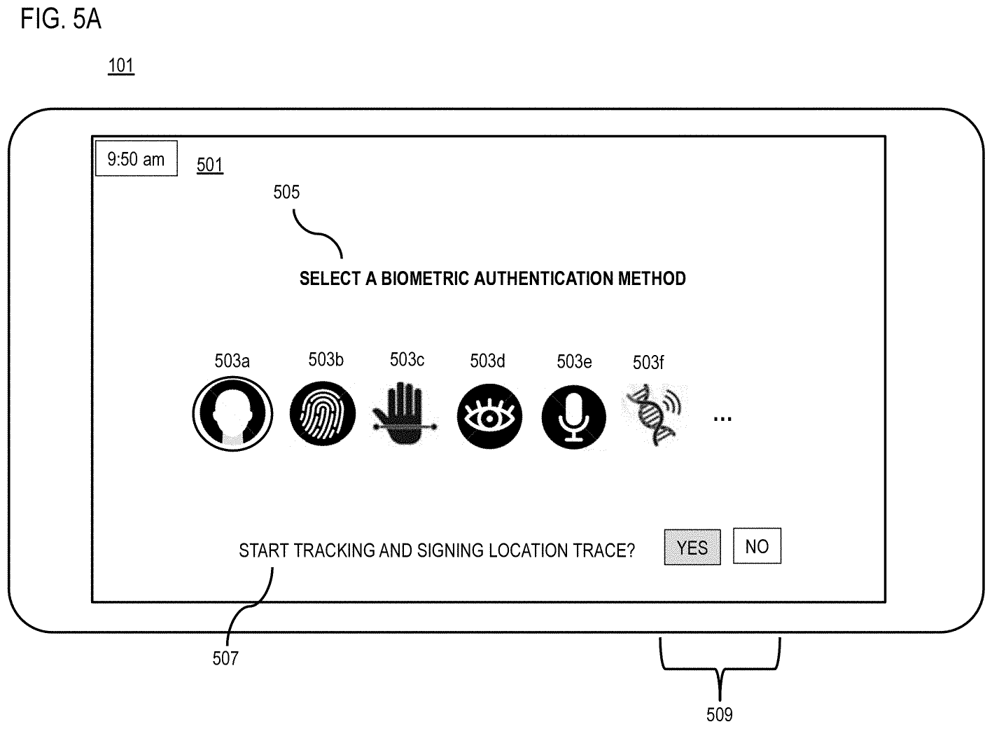

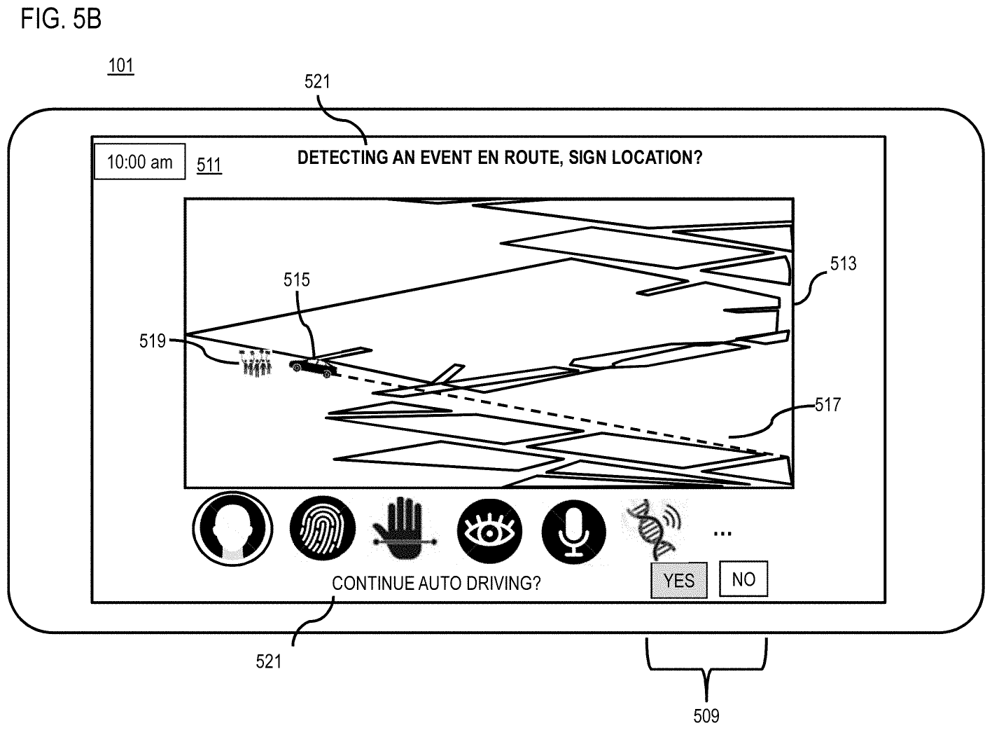

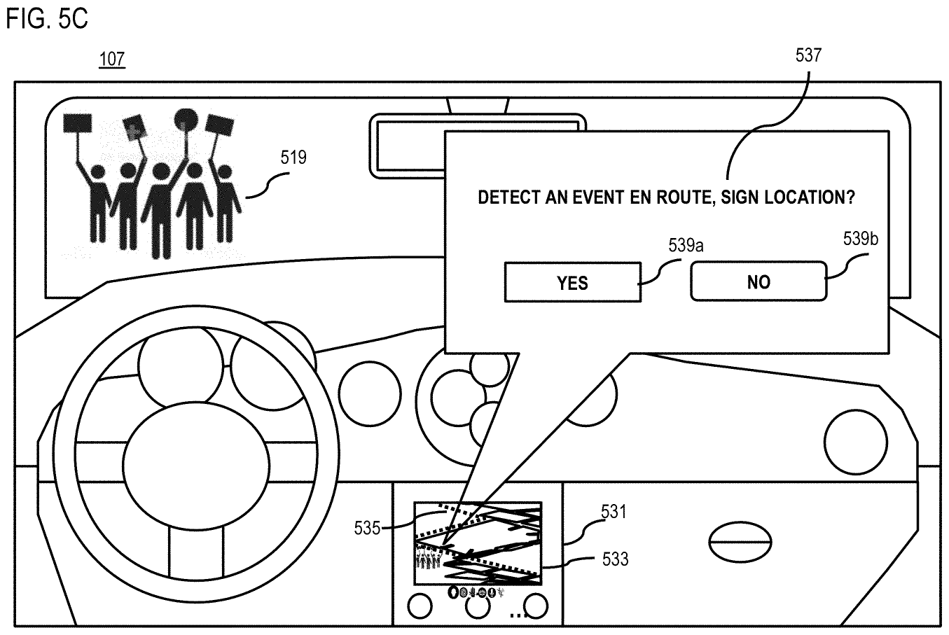

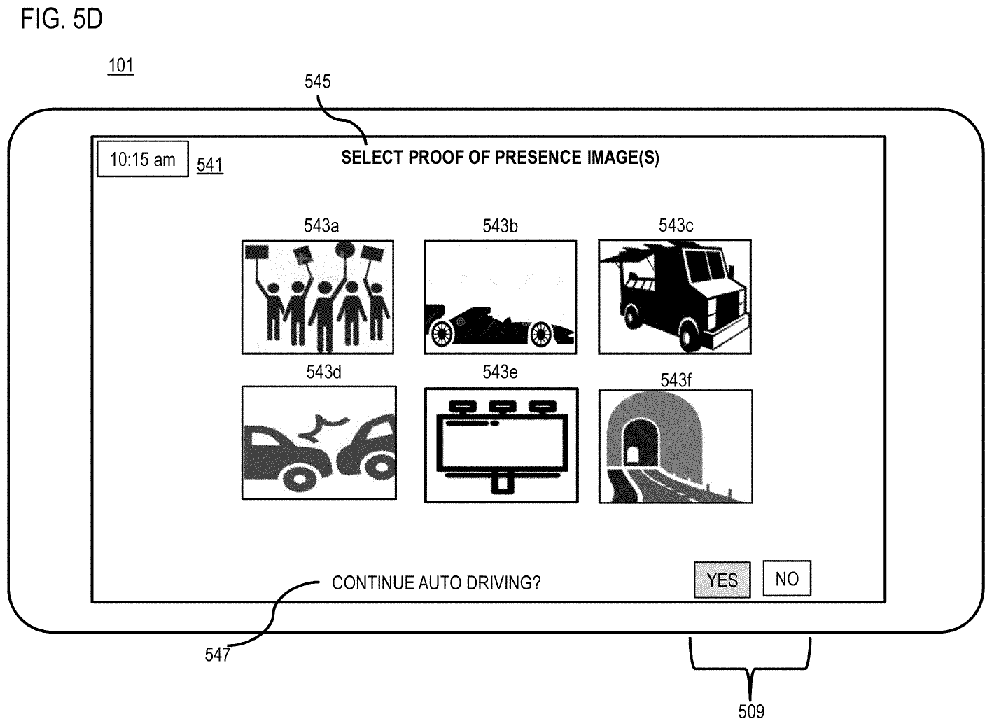

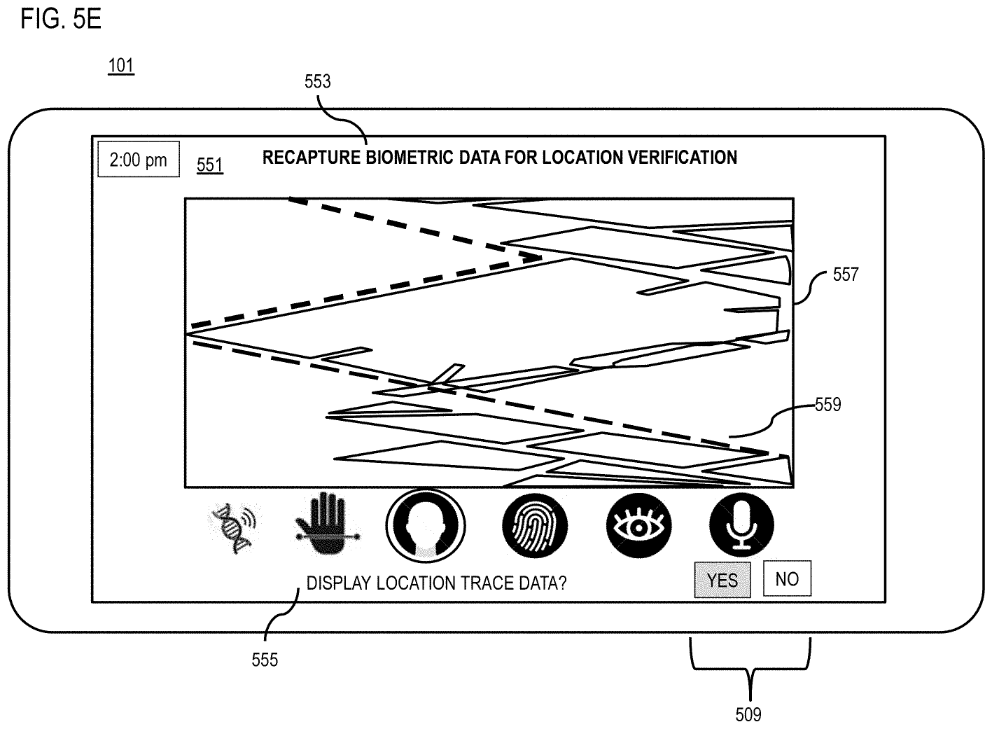

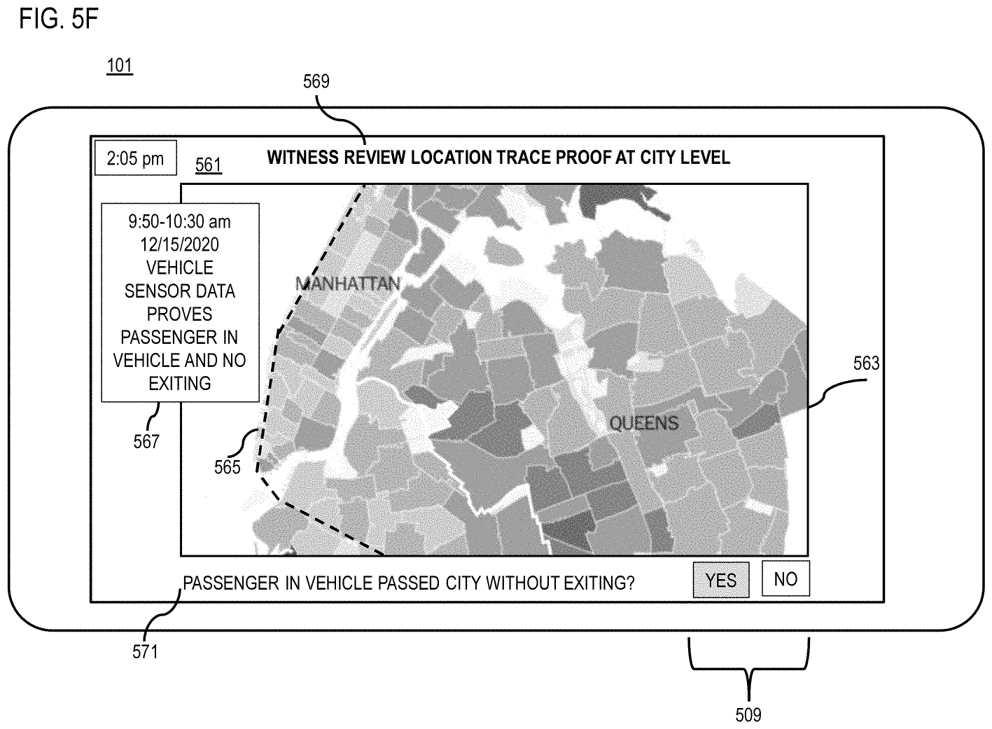

FIG. 3 is a diagram of the components of the location validation platform 111, according to one embodiment. By way of example, the location validation platform 111 includes one or more components for providing biometrically-signed location trace data at a device as a proof of user presence, according to the various embodiments described herein. It is contemplated that the functions of these components may be combined or performed by other components of equivalent functionality. In one embodiment, the location validation platform 111 includes a data processing module 301, a biometric mapping module 303, a presence module 305, and an output module 307 with connectivity to the geographic database 115. The above presented modules and components of the location validation platform 111 can be implemented in hardware, firmware, software, or a combination thereof. Though depicted as a separate entity in FIG. 1, it is contemplated that the location validation platform 111 may be implemented as a module of any other component of the system 100. In another embodiment, the location validation platform 111, and/or the modules 301-307 may be implemented as a cloud-based service, local service, native application, or combination thereof. The functions of the location validation platform 111, and/or the modules 301-307 are discussed with respect to FIGS. 4-5F.

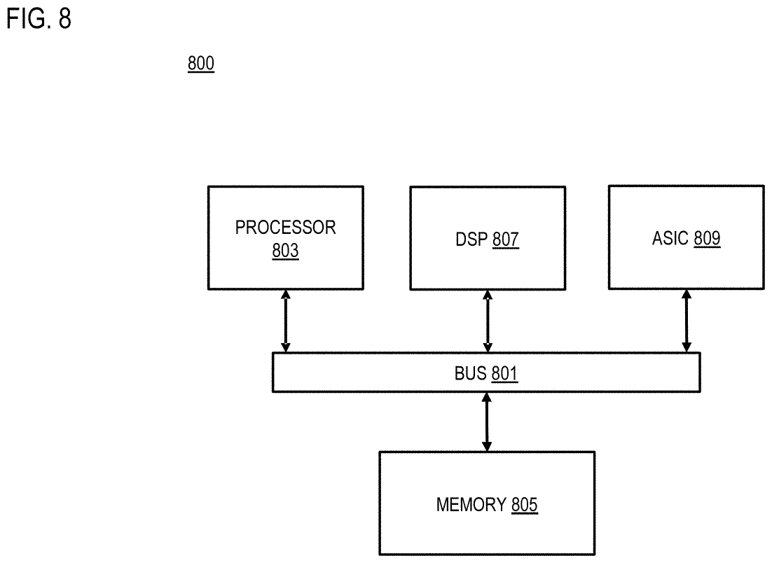

FIG. 4 is a flowchart of a process for providing biometrically-signed location trace data at a device as a proof of user presence, according to one or more example embodiments. In various embodiments, the location validation platform 111, and/or any of the modules 301-307 may perform one or more portions of the process 400 and may be implemented in, for instance, a chip set including a processor and a memory as shown in FIG. 8. As such, the location validation platform 111 and/or the modules 301-307 can provide means for accomplishing various parts of the process 400, as well as means for accomplishing embodiments of other processes described herein in conjunction with other components of the system 100. The steps of the process 400 can be performed by any feasible entity, such as the location validation platform 111, the modules 301-307, etc. Although the process 400 is illustrated and described as a sequence of steps, it is contemplated that various embodiments of the process 400 may be performed in any order or combination and need not include all the illustrated steps.

In one embodiment, in step 401, the data processing module 301 can initiate a transmission of location data (e.g., location coordinates) generated by one or more location sensors (e.g., a GPS receiver) of a device (e.g., the user device 203). In response to the transmission, in one embodiment, in step 403, the biometric mapping module 303 can work in conjunction with the data processing module 301 to receive a challenge generated for the location data (e.g., the challenge randomly generated by the server 207 in FIG. 2A).

FIGS. 5A-5F are diagrams of example user interfaces utilized in providing biometrically-signed location trace data at a device as a proof of user presence, according to one or more example embodiments. In FIG. 5A, in one embodiment, the biometric mapping module 303 can work in conjunction with the output module 307 to generate a user interface (UI) 501 for a UE 101 or the user device 203 (e.g., a mobile device with applications 105) that include one or more biometric applications, etc.,) that can enable a user (e.g., a pedestrian, a passenger of a vehicle 107, etc.) to take biometric data while stopping at a location, walking, running, traveling (e.g., in the vehicle 107), etc. In one instance, the biometric mapping module 303 can generate the UI 501 such that it includes a plurality of biometric application icons, such as a facial ID icon 503a, fingerprint icon 503b, a hand geometry icon 503c, an iris scanning icon 503d, a voiceprint icon 503e, a DNA icon 503f, etc.

In one embodiment, in step 405, the biometric mapping module 303 can generate a biometric mapping message based on the challenge and biometric data of a user (e.g., face). The user can be the person associated with the device (e.g., the user device 203) at a time the location data was generated. In one embodiment, the biometric data is based on a stable biometric mapping of the user (e.g., facial recognition, fingerprints, hand geometry, retinal scanning, iris scanning, vein pattern, voice recognition, electrocardiograms, DNA, odor/scent, etc.) into a biometric string (e.g., 128-bit). By way of example, the biometric data can be captured from time to time, periodically, on demand by the user (e.g., to unlock the user device 203), the public entity 201 (e.g., to track the user), the user device 203, the vehicle 205 (e.g., at the beginning and/or an end of the vehicle ride, passing a containment area, a stop exceeding a time threshold, a sudden brake, a crash, etc.), the server 207 (e.g., same triggers as the vehicle/public entity), the system 100 (e.g., same triggers as the vehicle/public entity), based on one or more triggering events, etc.

Referring to FIG. 5A, in this example, the biometric mapping module 303 can generate the UI 501 such that it includes a prompt 505: “Select a biometric authentication method.” For example, after a user selection of the facial recognition icon 503a, the biometric mapping module 303 can further generate the UI 501 such that it includes a query 507: “Start tracking and signing location trace?” and an input 509 with two buttons (e.g., “Yes” and “No”).

FIG. 5B depicts an example of an event-triggering biometrically location signing instance. In FIG. 5B, in one embodiment, the biometric mapping module 303 can work in conjunction with the output module 307 to generate a UI 511 for a UE 101 or the user device 203 that can enable a user to take biometric data while traveling (e.g., in the vehicle 205 in FIG. 2A). In one instance, the biometric mapping module 303 can generate the UI 501 such that it includes the biometric application icons 503a-503f, and a map 513. For instance, the map 513 can depict a vehicle 515 (e.g., the vehicle 205) carrying the user, a path 517 taken by the vehicle 515, and an event 519 (e.g., a strike). In this example, the biometric mapping module 303 can generate the UI 501 such that it includes a prompt 521: “Detecting an event en route, sign location?”, and can receive a user selection of the input 509 with two buttons (e.g., “Yes” and “No”) to determine whether to biometrically sign the current location and/or the location of the event 519 (e.g., the strike). In addition, the biometric mapping module 303 can further generate the UI 501 such that it includes a query 521: “Continue AUTO driving?” and can receive a user selection of the input 509 to determine whether to switch out of autonomous driving for the event 519 (e.g., the strike).

FIG. 5C depicts the example of an event-triggering biometrically location signing instance of FIG. 5B, using a UI 531 of a vehicle (e.g., the vehicle 205, the vehicle 515, etc.). In FIG. 5C, in one embodiment, the biometric mapping module 303 can work in conjunction with the output module 307 to generate the UI 531 that can enable a user to take biometric data using a built-in camera (e.g., a camera behind a front seat) while riding in the vehicle. In one instance, the biometric mapping module 303 can generate the UI 531 such that it includes the biometric application icons 503a-503f and a map 533. For instance, the map 533 can depict a planned path 535 for the vehicle 515, and the event 519 (e.g., the strike also visible via the windshield). In this example, the biometric mapping module 303 can generate the UI 531 such that it includes a prompt 537: “Detect an event en route, sign location?”, and can receive a user selection of an input 539a (e.g., “Yes”) or an input 539b (e.g., “No”) to determine whether to biometrically sign the current location and/or the location of the event 519 (e.g., the strike).

In one embodiment, the biometric mapping message can be generated (e.g., by the user device 203 or the vehicle 205) by applying a hash function to the challenge (e.g., a 128-bit string) and the biometric data (e.g., a 128-bit string), and the challenge can be randomly generated. For instance, the hash function can stably map/hash (a challenge, a biometric string) into hash values (e.g., integers from 0 to 128), and there can be no collision by applying the hash function on the challenges and the biometric string. By way of example, the hash function can be integer key values of the challenges and the biometric string can be the mid-square method that squares the key values, and then takes out the middle r bits of the result, giving a value in the range 0 to 2r−1. Other examples of hash functions include a secure hash algorithm (SHA), such as SHA-1 that produces a 160-bit hash value (often called a “message digest”) from an arbitrary length string, Message Digest algorithm 5 (MD5) that produces a 128-bit hash value, Hash of Variable Length (HAVAL), etc. In one embodiment, the system 100 can determine the size of the random ID, the challenge, the biometric string, the hash function, etc. by balancing data security and data storage/retrieval efficiency.

In one embodiment, in step 407, the output module 307 can provide the biometric mapping message as an output (e.g., to the server 207 in FIG. 2A). Subsequently, the biometric mapping module 303 can work in conjunction with the output module 307 to transmit a request to retrieve the location data. In response to the request, the biometric mapping module 303 can receive the same challenge (e.g., from the server 207) previously generated for signing the location data. The biometric mapping module 303 can recapture the biometric data of the user and generate another biometric mapping message based on the challenge and the recaptured biometric data. The biometric mapping module 303 can work in conjunction with the output module 307 to transmit the another biometric mapping message (e.g., to the server 207), and receive the location data that is matched to the another biometric mapping message.

In one embodiment, the device (e.g., the user device 203) is associated with the passenger of the vehicle 205. In another embodiment, the device (e.g., the user device 203, a device built-in the vehicle 205, etc.) is associated with a vehicle (e.g., the vehicle 205), and the proof of the presence of the user indicates that the user is associated with the vehicle. For instance, the presence module 305 can work in conjunction with the data processing module 301 to retrieve sensor data from one or more sensors 109 (e.g., speed sensors, door sensors, safety belt sensors, seats sensors, audio sensors, window sensors, etc.) of the vehicle that is generated concurrently with the location data (e.g., generated by location sensors of the user device 203 and/or the sensors 109 of the vehicle 205). The presence module 305 can process the vehicle sensor data to determine that the user remained in the vehicle during a time duration associated with the location data. In addition, the presence module 305 can work in conjunction with the data processing module 301 to retrieve other data (e.g., location data) from one or more other devices (e.g., traffic/speed cameras via V2V/V2X/V2I information) with connectivity to the device (e.g., the user device 203, or a vehicle built-in device), and the proof of the presence of the user (e.g., within the vehicle 205 and along a vehicle path) is further based on the other data.

In one embodiment, the presence module 305 can trigger proactive requests to nearby devices/vehicles to “register” the user device 203/vehicle 205, i.e., to acknowledge the presence in a given area via V2V/V2X/V2I information.

In another embodiment, the presence module 305 can validate the proof of the presence of the user based on one or more check points where the vehicle 205 is visually or electronically inspected (e.g., x-ray, infrared, etc.). Examples of check points can include highway fee stations, speed cams, dedicated checking locations on routes, police stations, etc., i.e., a static approach.

In another embodiment, the presence module 305 can work in conjunction with the data processing module 301 to have the vehicle 205 receive a real-time request (e.g., a “real-time challenge” for a dynamic approach from the server 207) to validate the proof of the presence of the user. For instance, the real-time request includes an instruction to perform a route change, a maneuver (e.g., a lane change/overtake, to slow down, to speed up, etc.), and/or other tasks (e.g., taking a picture, turning on head lights, etc.), and the proof of the presence of the user can be validated based on detecting that the instruction has been performed in response to the real-time request. If the challenge is accepted and successfully completed by the vehicle 205, the location data would then be recorded for future use.

Based on constantly improving capabilities of modern vehicles (e.g., vehicles 101), the presence module 305 can leverage the vehicle sensors 109 e.g., using cameras and image segmentation, faces or detected objects to generate a proof of presence. For example, the vehicle sensors 109 may include infrared sensor(s), LiDAR, radar, sonar, camera(s) (e.g., visible, night vision, 3D, etc.), global positioning system (GPS), light sensor(s), orientation sensor(s), augmented with height sensor(s), acceleration sensor(s), tilt sensor(s), moisture sensor(s), pressure sensor(s), audio sensor(s) (e.g., microphone), ultrasound sensor(s), windshield wiper sensor(s), ignition sensor(s), brake pressure sensor(s), head/fog/hazard light sensor(s), automatic braking system (ABS) sensor(s), ultrasonic parking sensor(s), electronic stability control sensor(s), vehicle speed sensor(s), mass airflow sensor(s), engine speed sensor(s), oxygen sensor(s), spark knock sensor(s), coolant sensor(s), manifold absolute pressure (MAF) sensor(s), fuel temperature sensor(s), voltage sensor(s), camshaft position sensor(s), throttle position sensor(s), O2 monitor(s), O2 monitor(s), health sensor(s) (e.g. heart-rate monitor(s), blood pressure monitor(s), etc.), and/or other devices/sensors that can scan and record data within the vehicle 205 and/or data from the vehicle's surroundings.

In one embodiment, the presence module 305 can validate the proof of the presence of the user based on a sequential revealing of device information, and the device information can include additional sensor data from one or more additional sensors of the device (e.g., the user device 203, a device built-in the vehicle 205, etc.), from sensors of other device(s) (e.g., traffic cameras), from sensors of other vehicle(s) (e.g., vehicle(s), drone(s), etc. in vicinity of the vehicle 205), etc.

For instance, the vehicle 205 can prove its presence by providing the content of sensors 1, 2 and 3 (e.g., of the sensors 109). The presence module 305 can challenge this by requesting more information. In response, the vehicle 205 may decide to unlock and share data from sensors 4 and 5 (e.g., of the sensors 1090. With the additional information, the presence module 305 can then accept and register the location data.

As other instances, the vehicle 205 can identify which features around the vehicle 205 are likely to be ephemeral and thus capture them to prove its presence with more specific, detailed, and/or confidential content of one or more sensors (e.g., sensors 109), such as dynamic weather, a vehicle license number of a crossing vehicle, a timestamp and/or content on a digital billboard, combining multiple users with multiple faces, etc.

For example, a specific accident/incident on the road involving a car with a license plate (e.g., AA1234) can be used as a unique feature/event to be captured. Similarly, some specific physical or digital advertisement can be visible at a given area for a limited time. The vehicle 205 could then decide to prioritize which “features” around the vehicle as the likely to be valid proof of presence, and then capture them with the sensors 109. When challenging the vehicle to prove its presence at a given location, the presence module 305 can query a database (e.g., the geographic database 115) which could contain the relevant “features” (e.g., the specific accident involving vehicle AA1234 and how long this event lasted before the police evacuated the area, etc.).

The output of the biometric mapping message indicates a proof of a presence of the user within a proximity of the device (e.g., the user device 203) at the time the location data was generated, and the output of the presence module 305 indicates a proof of a presence of the user within a vehicle 205 (without exiting) while the vehicle passed an area of interest (e.g., a car crash, a strike, a contaminated area, etc.). In various embodiments, the user can be granted access to one or more legal rights (e.g., travel/gathering privileges, healthcare benefits, housing subsides, tax privileges, governmental grants, etc.), one or more products (e.g., sports tickets, theater/concert tickets, flight tickets, etc.), one or more services (e.g., restaurant dining, medical services, vaccines, public transports, public services (e.g., schools, libraries, etc.), hospitals/malls/supermarkets/work entries, etc.), or a combination thereof based on the proof of the presence of the user. By way of example, a user can also use the various embodiments described above to prove how many days the user spent in a primary residence in a given locality for the purposes of tax reporting.

From the prospective of the server 207, in one embodiment, the server 207 can receive location data generated by one or more location sensors of a device (e.g., the user device 203), generate a challenge for the location data, and then transmit the challenge back to the device. In response to the challenge, the server 207 can receive and store a biometric mapping message generated (e.g., by the user device 203) based on the challenge and biometric data of a user from the device. For instance, the biometric mapping message can be generated by applying a hash function to the challenge and the biometric data, and the biometric data can be based on a stable biometric mapping of the user. The user is understood to mean in this instance, the person associated with the device (e.g., a UE 101 and/or user device 203) at the time the location data was generated, and an output of the biometric mapping message indicates a proof of a presence of the user within a proximity of the device at the time the location data was generated.

Subsequently, the server 207 can receive a request (e.g., from a public entity 201, a user device 203, etc.) to retrieve the location data. In response to the request, the server 207 can transmit (e.g., to the user device 203) the challenge generated for the location data. In response to the challenge, the server 207 can receive (e.g., from the user device 203) another biometric mapping message based on the challenge and re-captured biometric data of the user (e.g., from the user device 203). The server 207 can then match the another biometric mapping message against the stored biometric mapping message, and transmit the location data to the device based on the match.

Form the prospective of the vehicle 205, in one embodiment, the vehicle 205 can retrieve sensor data from one or more sensors (e.g., speed sensors, door sensors, safety belt sensors, seats sensors, audio sensors, window sensors, etc.) of its own (e.g., sensors 109). The sensor data can be generated concurrently with location data generated by one or more location sensors of a device (e.g., the user device 203), the vehicle 205 (e.g., sensors 109), or a combination thereof. The vehicle 205 can process the sensor data to determine that a user remained in the vehicle 205 during a time duration associated with the location data, and grant or deny the user access to one or more legal rights (e.g., in conjunction with a public entity 201), one or more products, one or more services, or a combination thereof based on the determination. For instance, the location data can indicate that the vehicle passed via a contaminated area (e.g., by COVID-19, chemical, etc.).

In another embodiment, the presence module 305 can validate that the vehicle 205 traveled via the contaminated area (e.g., by COVID-19, chemical, etc.) during the time period based on at least one of (1) sensor data captured at one or more other devices (e.g., traffic/speed cameras), one or more other vehicles, one or more check points where the vehicle 205 is visually or electronically inspected (e.g., x-ray, infrared, etc.), or a combination thereof, and (2) one or more tasks (e.g., a route change, a maneuver, or other tasks) performed by the vehicle 205 in response to one or more real-time challenges (e.g., issued by the server 207). In this embodiment, the user access can be granted or denied further based on the validation.

By way of example, the one or more other vehicles (e.g., vehicles 107) which detected the vehicle 205 can automatically request V2V information to document the location data and/or send the location data to the server 207 or a cloud. The V2V information can include (1) IDs and other identification of the vehicle(s), (2) location(s) and timestamp(s) recorded by the vehicles, (3) the number of occupants in each vehicle based on car seat sensors, safety belt sensors, etc., (4) sensor status (e.g., seat belts, air bags, heat sensor, battery/gasoline, vehicles weights, etc.), (5) a predetermined time period (e.g., 2 minutes) of audio and/or video feeds, etc. In one embodiment, the V2V information can be saved for a predetermined time period (e.g., 15 minutes of traces/logs), and stored in a safe manner (e.g., in a centralized entity, such as a Blackbox and/or using a distributed mechanism, such as Blockchain) and/or in the geographic database 115. By analogy, the one or more other devices (e.g., traffic/speed cameras) which detected the vehicle 205 can automatically request V2X information to document the location data and/or send the location data to the server 207 or a cloud, and the V2X/V2I information can share some or all of the content of the V2V information.

In yet another embodiment, in response to a receipt of a challenge (e.g., from the server 207), the vehicle 205 can generate a biometric mapping message based on the challenge and biometric data of a user (e.g., from the user device 203), and retrieve the location data (e.g., from the server 207) by responding to a subsequent receipt of the challenge (e.g., from the server 207) with another biometric mapping message generated based on the challenge and re-captured biometric data of the user (e.g., from the user device 203). In this embodiment, the user access can be granted or denied further based on the retrieved location data.

In FIG. 5D, in one embodiment, the system 100 can generate a UI 541 for a UE 101, the user device 203, and/or the built-in display in the vehicle 205 as shown in FIG. 5C that can present a list of captured images from a period of time (e.g., the last three minutes) that seem to be the relevant to an area of interest. As described with respect to FIG. 2B, the vehicle 205 can scan its environment with its sensors 109 (e.g., radar, LiDAR, cameras, etc.) to detect the relevant elements around to capture as a proof of presence at a location or en route. In one instance, the system 100 can generate the UI 541 such that it includes a plurality of images, such as a strike on a sidewalk image 543a, a sports car on the road image 543b, a food truck at a street corner image 543c, a collision image 543d, a digital-billiard image with time and temperature 543e, a tunnel digital traffic sign image with speed and traffic forecast 543f, etc.

In this example, the system 100 can generate the UI 541 such that it includes a prompt 545: “Select proof of presence image(s)”, and can receive a user selection of one or more of the images 543a-534f displayed in the UI 541 as proof of presence at the location. For example, the user can select/validate the images (e.g., the strike image 543a) that appear to properly capture the event 519 (e.g., the strike) at the location and time. The system 100 can store the location-proof data locally in the user device 203 and/or the vehicle 205, and/or externally (e.g., in the server 207, the geographic database 115, or a cloud). The system 100 can then generate the UI 541 such that it includes a query 547: “Continue AUTO driving?” and can receive a user selection of the input 509 (e.g., “Yes” and “No”) to determine whether to switch out of autonomous driving for the event 519 (e.g., the strike).

Subsequently, when the system 100 needs to prove that a vehicle 205 previously visited the location (e.g., the strike) or to prove that the vehicle 205 never visited a location at issue (e.g., COVID-19), the system 100 can query the server 207 based on a location and/or a time at issue, and then the server 207 can extract context (e.g., a location, a time, etc.) from the captured image(s) to match the extracted context with the location and/or the time at issue for verification (i.e., a proof of presence of the vehicle 205). This can prove the vehicle 205 was indeed at the location/area of the respective time period.

To further provide information or data that a passenger was indeed in the vehicle 205 at the previously visited location and time, the system 100 can apply the process depicted in FIG. 5E. FIG. 5E depicts an example of unlocking biometrically-signed location data of a user. In FIG. 5E, in one embodiment, the system 100 can generate a UI 551 for a UE 101 or the user device 203 that can enable a user to re-capture biometric data. In one instance, the system 100 can generate the UI 551 such that it includes the biometric application icons 503a-503f, and a prompt 553: “Recapture biometric data for location verification.” In this example, after the user takes a face image using the UI 551, the system 100 can unlock the location trace data from the server 207 based on the ladder diagram described in FIG. 2A. The system 100 can include in the UI 551 a query 555: “Display location trace data?”, and can receive a user selection of the input 509 with two buttons (e.g., “Yes” and “No”) to determine whether to display the location trace data. After receiving a user selection of “Yes”, the system 100 can include in the UI 551 a map 557 showing a path 559 taken by the vehicle 205 (e.g., during 9:50-10:30 on Dec. 15, 2020). In other words, at 2:00 pm, the UI 551 presents an earlier location trace of 9:50-10:30 am.

Although various embodiments are described with respect to an autonomous vehicle, it is contemplated that the approaches of the various embodiments described herein are applicable to any types vehicles.

After a witness has already observed the unlocking process of the biometrically-signed location data of the user in FIG. 5E, the witness can attest the unlocked location data as follows. FIG. 5F depicts an example of witnessing unlocked biometrically-signed location trace data. In FIG. 5F, in one embodiment, the system 100 can generate a UI 561 for a UE 101 or the user device 203 to enable a witness to attest to location trace data of a user that was biometrically-signed and then unlocked.

In one instance, the system 100 can generate the UI 561 such that it includes a map 563 with a path 565 and a location trace proof statement 567: “9:50-10:30 12/15/2020 Vehicle Sensor Data Proves Passenger in Vehicle and No Exiting.” In this example, the map 563 can be a zoomed-out version of the map 557 of FIG. 5E at a city level (e.g., New York City). The system 100 can generate the UI 561 such that it includes a prompt 569: “Witness review location trace proof at city level,” and a query 571: “Passenger in vehicle passed city without exiting?” The system 100 can then receive a witness selection via the input 509 (e.g., “Yes” and “No”) to determine whether the passenger in the vehicle passed the city without stopping during 9:50-10:30 on Dec. 15, 2020. Therefore, the system 100 can prove that the passenger(s)/vehicle visited the contaminated areas in New York City yet the passenger(s) remained in the vehicle without being exposed, e.g., because the vehicle never stopped and/or the passenger(s) never left/exited the vehicle. Similarly, the system 100 can prove that the passenger(s)/vehicle has not visited a contaminated area (e.g., COVID-19) based on biometrically-signed location trace data of a user (e.g., based on sensor data associated with a UE 101/user device 203).

In one instance, the system 100 can also collect the real-time sensor data and/or V2V information from one or more UEs 101 (e.g., mobile devices, smartphones, etc.) associated with the vehicles 107. In one instance, the UEs 101 may include applications 105 (e.g., biometric applications). In one embodiment, the location validation platform 111 is connected to the UEs 101, the vehicles 107, or a combination thereof via a communication network 113. The sensor data collected by the UEs 101 and/or the vehicles 107 may be stored a geographic database 115.

In one embodiment, the system 100 may also collect real-time sensor data and/or traffic information from one or more other sources such as government/municipality agencies, local or community agencies (e.g., a police department), and/or third-party official/semi-official sources (e.g., a services platform 117, one or more services 119a-119n (collectively referred to as services 119), one or more content providers 121a-121m (collectively referred to as content providers 121), etc.

In another embodiment, the sensor information can be supplemented with additional information from network-based services such as those provided by the services platform 117 and the services 119. By way of example, the services 119 can include mapping services, navigation services, and/or other data services that provide data for providing biometrically-signed location trace data at a device (e.g., the user device 203) as a proof of user presence. In one embodiment, the services platform 117 and/or the services 119 can provide contextual information such as weather, traffic, etc. as well as facilitate communications (e.g., via social networking services, messaging services, crowdsourcing services, etc.) among vehicles 107 to share configuration information. In one embodiment, the services platform 117 and/or the services 119 interact with content providers 121 who can provide content data (e.g., map data, imaging data, etc.) to the services platform 117 and/or the services 119. In one embodiment, the UE 101 executes an application 105 that acts as client to the location validation platform 111, the services platform 117, the services 119, and/or the content providers 121. In one embodiment, the sensor data, contextual information, and/or configuration information can be stored in a database (e.g., the geographic database 115) for use by the location validation platform 111. All information shared by the system 100 should be filtered via privacy policy and rules set by the system 100 and/or data owners, such as removing personal information before sharing with third parties.

Although various embodiments are described with respect to user/vehicle moving scenarios, it is contemplated that the approach described herein may be used to verify the location(s) of user/vehicle confined/stopping scenarios. For instances, a user under quarantine, a home detainment, etc., can biometrically sign location trace data for location verification. As other instances, a shuttle/taxi/delivery truck standing/stopping for pick-ups and/or drop-offs can collect V2V/V2X information, perform real-time challenges, sequentially release sensor data, etc. for location verification.

The above-discussed embodiments can support a user to prove the user was near a reference device (i.e., a mobile device 101 collecting location trace data) by signing device-generated location traces with the user's biometric data. Such a stable biometric mapping (e.g. face recognition, fingerprint, retina scan, etc.) can generate a unique string for the user for unlocking the location traces later for location verification, while maintaining user biometric data privacy.

The above-discussed embodiments can collect vehicle sensor 109 data (e.g., speed data, door sensor data, safety belt sensor data, seats sensor data, audio sensor data, window sensor data, etc.) as a proof that a user was or was not in a given area (e.g., a car crash scene, a contaminated area, etc.), and left or did not leave the vehicle 107 in the area (i.e., passing the area without exiting the vehicle). In addition, the above-discussed embodiments can collect V2V/V2X/V2I information, perform real-time challenges, sequentially releasee sensor data, etc. for further location verification.

Returning to FIG. 1, in one embodiment, the location validation platform 111 has connectivity over the communication network 113 to the services platform 117 (e.g., an OEM platform) that provides services 119 (e.g., probe and/or sensor data collection services). By way of example, the services 119 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output of the location validation platform 111 to provide products and/or services such as navigation, mapping, other location-based services, etc.

In one embodiment, the location validation platform 111 may be a platform with multiple interconnected components. The location validation platform 111 may include multiple servers, intelligent networking devices, computing devices, components, and corresponding software for providing parametric representations of lane lines. In addition, it is noted that the location validation platform 111 may be a separate entity of the system 100, a part of the services platform 117, a part of the one or more services 119, or included within the vehicles 107 (e.g., an embedded navigation system).

In one embodiment, content providers 121 may provide content or data (e.g., including probe data, sensor data, etc.) to the location validation platform 111, the UEs 101, the applications 105, the geographic database 115, the services platform 117, the services 119, and the vehicles 107. The content provided may be any type of content, such as map content, textual content, audio content, video content, image content, etc. In one embodiment, the content providers 121 may provide content that may aid in localizing a vehicle path or trajectory on a lane of a digital map or link. In one embodiment, the content providers 121 may also store content associated with the location validation platform 111, the geographic database 115, the services platform 117, the services 119, and/or the vehicles 107. In another embodiment, the content providers 121 may manage access to a central repository of data, and offer a consistent, standard interface to data, such as a repository of the geographic database 115.

By way of example, the UEs 101 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 101 can support any type of interface to the user (such as “wearable” circuitry, etc.). In one embodiment, a UE 101 may be associated with a vehicle 107 (e.g., a mobile device) or be a component part of the vehicle 107 (e.g., an embedded navigation system). In one embodiment, the UEs 101 may include the location validation platform 111 to provide biometrically-signed location trace data at a device as a proof of user presence.

In one embodiment, as mentioned above, the vehicles 107, for instance, are part of a probe-based system for collecting probe data and/or sensor data for providing biometrically-signed location trace data at a device as a proof of user presence. In one embodiment, each vehicle 107 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 107 may include sensors 109 for reporting measuring and/or reporting attributes. The attributes can also be any attribute normally collected by an on-board diagnostic (OBD) system of the vehicle 107, and available through an interface to the OBD system (e.g., OBD II interface or other similar interface).

The probe points can be reported from the vehicles 107 in real-time, in batches, continuously, or at any other frequency requested by the system 100 over, for instance, the communication network 113 for processing by the location validation platform 111. The probe points also can be map matched to specific road links stored in the geographic database 115. In one embodiment, the system 100 (e.g., via the location validation platform 111) can generate probe traces (e.g., vehicle paths or trajectories) from the probe points for an individual probe so that the probe traces represent a travel trajectory or vehicle path of the probe through a road network.

In one embodiment, as previously stated, the vehicles 107 are configured with various sensors (e.g., vehicle sensors 109) for generating or collecting probe data, sensor data, related geographic/map data, etc. In one embodiment, the sensed data represents sensor data associated with a geographic location or coordinates at which the sensor data was collected. By way of example, the vehicle sensors 109 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 107, switch sensors for determining whether one or more vehicle switches are engaged, and the like. Though depicted as automobiles, it is contemplated the vehicles 107 can be any type of vehicle manned or unmanned (e.g., cars, trucks, buses, vans, motorcycles, scooters, drones, etc.) that travel through road segments of a road network.

Other examples of sensors 109 of the vehicles 107 may include light sensors, orientation sensors augmented with height sensors and acceleration sensor (e.g., an accelerometer can measure acceleration and can be used to determine orientation of the vehicle), tilt sensors to detect the degree of incline or decline of the vehicles 107 along a path of travel (e.g., while on a hill or a cliff), moisture sensors, pressure sensors, etc. In a further example embodiment, sensors 109 about the perimeter of the vehicles 107 may detect the relative distance of the vehicle 107 from a physical divider, a lane line of a link or roadway, the presence of other vehicles, drones, pedestrians, traffic lights, potholes and any other objects, or a combination thereof. In one scenario, the vehicle sensors 109 may detect weather data, traffic information, or a combination thereof. In one embodiment, the vehicles 107 may include GPS or other satellite-based receivers to obtain geographic coordinates from satellites 123 for determining current location and time. Further, the location can be determined by visual odometry, triangulation systems such as A-GPS, Cell of Origin, or other location extrapolation technologies.

In one embodiment, the UEs 101 may also be configured with various sensors (not shown for illustrative convenience) for acquiring and/or generating probe data and/or sensor data associated with a vehicle 107, a driver, other vehicles, conditions regarding the driving environment or roadway, etc. For example, such sensors may be used as GPS receivers for interacting with the one or more satellites 123 to determine and track the current speed, position, and location of a vehicle 107 travelling along a link or roadway. In addition, the sensors may gather tilt data (e.g., a degree of incline or decline of the vehicle during travel), motion data, light data, sound data, image data, weather data, temporal data and other data associated with the vehicles 107 and/or UEs 101. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via communication network 113 as probe data (e.g., GPS probe data) according to any known wireless communication protocols. For example, each UE 101, application 105, user, and/or vehicle 107 may be assigned a unique probe identifier (probe ID) for use in reporting or transmitting said probe data collected by the vehicles 107 and/or UEs 101. In one embodiment, each vehicle 107 and/or UE 101 is configured to report probe data as probe points, which are individual data records collected at a point in time that records telemetry data.

In one embodiment, the location validation platform 111 retrieves aggregated probe points gathered and/or generated by the vehicle sensors 109 and/or the UEs 101 resulting from the travel of the UEs 101 and/or vehicles 107 on a road segment of a road network. In one instance, the geographic database 115 stores a plurality of probe points and/or trajectories generated by different vehicle sensors 109, UEs 101, applications 105, vehicles 107, etc. over a period while traveling in a monitored area. A time sequence of probe points specifies a trajectory—i.e., a path traversed by a UE 101, application 105, vehicle 107, etc. over the period.

In one embodiment, the communication network 113 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 107, vehicle sensors 109, location validation platform 111, UEs 101, applications 105, services platform 117, services 119, content providers 121, and/or satellites 123 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

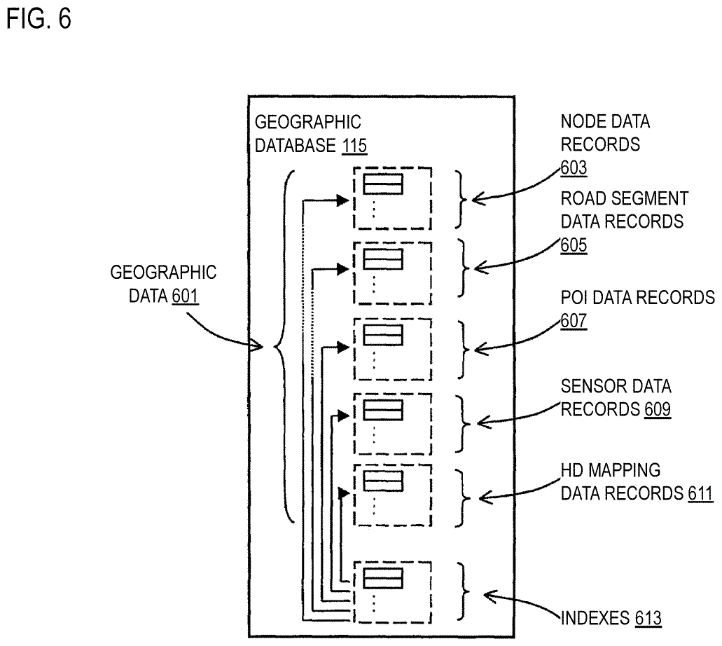

FIG. 6 is a diagram of a geographic database (such as the database 115), according to one embodiment. In one embodiment, the geographic database 115 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on LiDAR or equivalent technology to collect billions of 3D points and model road surfaces and other map features down to the number lanes and their widths. In one embodiment, the mapping data (e.g., data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 603, road segment or link data records 605, POI data records 607, sensor data records 609, mapping data records 611, and indexes 613, for example. More, fewer, or different data records can be provided. In one embodiment, additional data records (not shown) can include cartographic (“cartel”) data records, routing data, and maneuver data. In one embodiment, the indexes 613 may improve the speed of data retrieval operations in the geographic database 115. In one embodiment, the indexes 613 may be used to quickly locate data without having to search every row in the geographic database 115 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points corresponding to the respective links or segments of the road segment data records 605. The road link data records 605 and the node data records 603 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 607. The geographic database 115 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, the geographic database 115 can also include sensor data records 609 for storing biometric mapping messages, location trace data entries, user device sensor data, vehicle sensor data, other device sensor data, and/or any other data generated or used by the system 100 according to the various embodiments described herein. By way of example, the sensor data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles 107 and other end user devices with near real-time speed without overloading the available resources of the vehicles 107 and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 121 in association with the services platform 117 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 107 and/or with user terminals 101) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 107 or a user terminal 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing biometrically-signed location trace data at a device as a proof of user presence may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

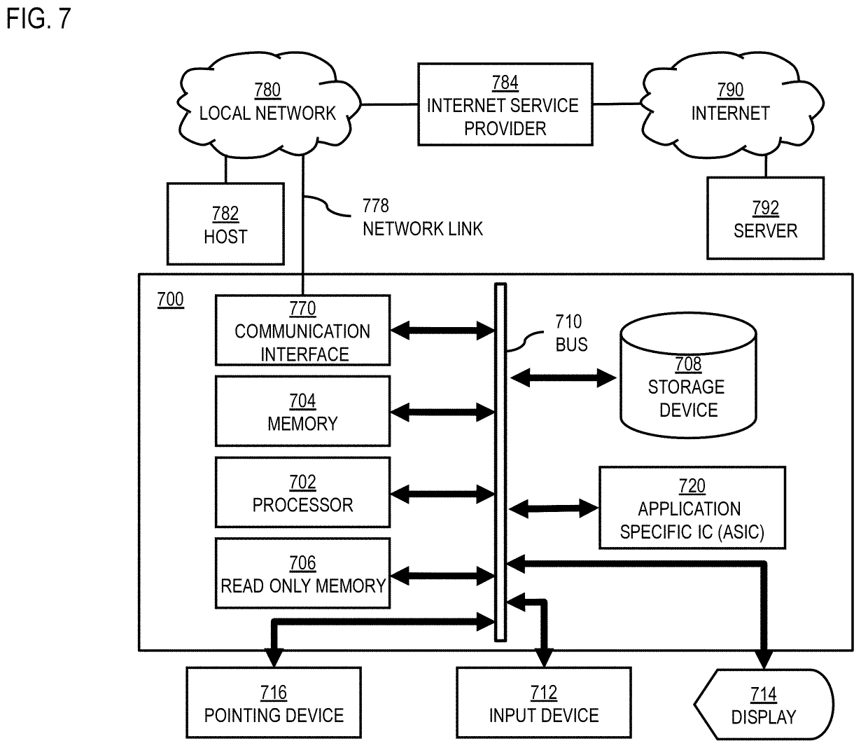

FIG. 7 illustrates a computer system 700 upon which an embodiment of the invention may be implemented. Computer system 700 is programmed (e.g., via computer program code or instructions) to provide biometrically-signed location trace data at a device as a proof of user presence as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing biometrically-signed location trace data at a device as a proof of user presence. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for providing biometrically-signed location trace data at a device as a proof of user presence. Dynamic memory allows information stored therein to be changed by the computer system 700. RANI allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing biometrically-signed location trace data at a device as a proof of user presence, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 113 for providing biometrically-signed location trace data at a device as a proof of user presence.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to provide biometrically-signed location trace data at a device as a proof of user presence as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide biometrically-signed location trace data at a device as a proof of user presence. The memory 805 also stores the data associated with or generated by the execution of the inventive steps.

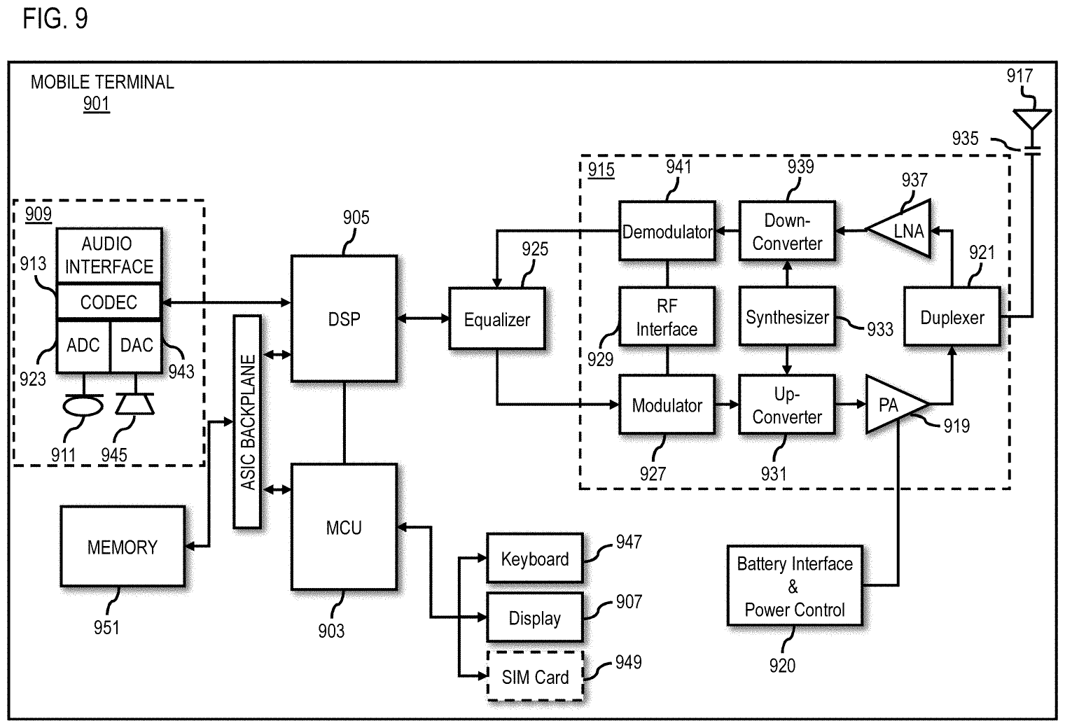

FIG. 9 is a diagram of exemplary components of a mobile terminal 901 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide biometrically-signed location trace data at a device as a proof of user presence. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating a transmission of location data generated by one or more location sensors of a device;
in response to the transmission, receiving a challenge generated for the location data;
generating a biometric mapping message based on the challenge and biometric data of a user, wherein the user is associated with the device at a time the location data was generated; and
providing the biometric mapping message as an output,
wherein the output of the biometric mapping message indicates a proof of a presence of the user within a proximity of the device at the time the location data was generated.

2. The method of claim 1, wherein the generating of the biometric mapping message comprises applying a hash function to the challenge and the biometric data.

3. The method of claim 1, wherein the biometric data is based on a stable biometric mapping of the user.

4. The method of claim 1, further comprising:
transmitting a request to retrieve the location data;
in response to the request, receiving the challenge generated for the location data;
generating another biometric mapping message based on the challenge and the biometric data of the user;
transmitting the another biometric mapping message; and
receiving the location data that is matched to the another biometric mapping message.

5. The method of claim 1, wherein the device is associated with a vehicle, and wherein the proof of the presence of the user indicates that the user is associated with the vehicle.

6. The method of claim 5, further comprising:
retrieving sensor data from one or more sensors of the vehicle that is generated concurrently with the location data;
processing the sensor data to determine that the user remained in the vehicle during a time duration associated with the location data.

7. The method of claim 1, further comprising:
retrieving other data from one or more other devices with connectivity to the device, wherein the proof of the presence of the user is further based on the other data.

8. The method of claim 1, further comprising:
validating the proof of the presence of the user based on one or more check points.

9. The method of claim 1, further comprising:
receiving a real-time request to validate the proof of the presence of the user, wherein the real-time request includes an instruction to perform a route change, a maneuver, a task, or a combination thereof,
wherein the proof of the presence of the user is validated based on detecting that the instruction has been performed in response to the real-time request.

10. The method of claim 1, further comprising:
validating the proof of the presence of the user based on a sequential revealing of device information,
wherein the device information includes additional sensor data from one or more additional sensors of the device.

11. The method of claim 1, wherein the challenge is randomly generated.

12. The method of claim 1, wherein the user is granted access to one or more legal rights, one or more products, one or more services, or a combination thereof based on the proof of the presence of the user.

13. An apparatus comprising:
at least one processor; and
at least one memory including computer program code for one or more programs,
the at least one memory and the computer program code configured to, with the at least one processor, cause the apparatus to perform at least the following,
receive location data generated by one or more location sensors of a device;
generate a challenge for the location data;
transmit the challenge to the device;
in response to the challenge, receive and store a biometric mapping message generated based on the challenge and biometric data of a user from the device, wherein the user is associated with the device at a time the location data was generated, and wherein an output of the biometric mapping message indicates a proof of a presence of the user within a proximity of the device at the time the location data was generated.

14. The apparatus of claim 13, wherein the biometric mapping message is generated by applying a hash function to the challenge and the biometric data.

15. The apparatus of claim 13, wherein the biometric data is based on a stable biometric mapping of the user.

16. The apparatus of claim 13, wherein the apparatus is further caused to:
receive a request to retrieve the location data;
in response to the request, transmit the challenge generated for the location data;
in response to the challenge, receive another biometric mapping message based on the challenge and re-captured biometric data of the user;
match the another biometric mapping message against the stored biometric mapping message; and
transmit the location data to the device based on the match.

17. A non-transitory computer readable storage medium including one or more sequences of one or more instructions which, when executed by one or more processors, cause an apparatus to at least perform:
retrieving sensor data from one or more sensors of a vehicle that is generated concurrently with location data generated by one or more location sensors of a device, the vehicle, or a combination thereof;
processing the sensor data to determine that a user remained in the vehicle during a time duration associated with the location data; and
granting or denying the user access to one or more legal rights, one or more products, one or more services, or a combination thereof based on the determination.

18. The non-transitory computer readable storage medium of claim 17, wherein the location data indicates that the vehicle passed via a contaminated area.

19. The non-transitory computer readable storage medium of claim 18, wherein the apparatus is further caused to perform:
validating that the vehicle traveled via the contaminated area during the time period based on at least one of (1) sensor data captured at one or more other devices, one or more other vehicles, one or more check points, or a combination thereof, and (2) one or more tasks performed by the vehicle in response to one or more real-time challenges,
wherein the user access is granted or denied further based on the validation.

20. The non-transitory computer readable storage medium of claim 19, wherein the apparatus is further caused to perform:
in response to a receipt of a challenge, generating a biometric mapping message based on the challenge and biometric data of a user; and
retrieving the location data by responding to a subsequent receipt of the challenge with another biometric mapping message generated based on the challenge and re-captured biometric data of the user,
wherein the user access is granted or denied further based on the retrieved location data.
